(19) United States
(12) Patent Application Publication
(10) Pub. No.: US 2018/0250680 A1
(43) Pub. Date: Sep. 6, 2018

(54) Jaw Crusher Taper Lock Arrangement

(71) Applicant: Lippmann - Milwaukee, Inc., Cudahy, WI (US)

(72) Inventors: Joseph Paul Martinez, JR., Waukesha, WI (US); David Peter Phelan, Woodville (CA)

(21) Appl. No.: 15/881,077

(22) Filed: Jan. 26, 2018

Related U.S. Application Data
(60) Provisional application No. 62/466,788, filed on Mar. 3, 2017.

(51) Int. Cl. B02C 1/04; B02C 1/00

(52) U.S. Cl. CPC B02C 1/04; B02C 2210/02; B02C 2201/00; B02C 1/005

(57) ABSTRACT

A toggle block adjustment arrangement for a jaw crusher is provided.

### CROSS-REFERENCE TO RELATED PATENT APPLICATION

The present application claims the benefit of and priority to U.S. Provisional Application No. 62/466,788 filed on Mar. 3, 2017, which is incorporated herein by reference in its entirety.

### FIELD OF THE INVENTION

This invention generally relates to jaw crushers. More specifically, this invention relates to mechanisms for securing the adjustable toggle block of a jaw crusher.

### BACKGROUND OF THE INVENTION

Jaw crushers generally include a stationary jaw plate and a movable jaw plate. The movable jaw plate must be very firmly maintained in position during operation of the jaw crusher, which exerts tremendous force on the movable plate adjustment mechanism, most especially during crushing of very durable materials. The crush size is typically determined by the arrangement of a fulcrumed toggle plate and toggle block at one end of the movable jaw of the jaw crusher. The movable toggle block is typically maintained in position by means of wedges which are securely bolted to the main frame of the jaw crusher. Thus, to make any adjustment of the movable jaw, for example to change the crush size or to adjust for wear of the jaw plates, the wedges are typically individually unbolted from the jaw crusher frame, releasing the toggle block for lateral adjustment. Due to the high stresses induced by repeated impacts during crushing, adjustment hardware such as bolts may become extremely difficult to loosen for adjustment. Additionally, the presence of very fine particulates and dust may further lock adjustment bolts, making manual removal a very laborious and time-consuming process.

Thus, it would be advantageous to releasable secure a toggle block within a jaw crusher in a manner allowing mechanical securement and release. Additionally, it would be advantageous to provide components suitable for adding the adjustment mechanism of the present invention to existing jaw crusher which include a typical bolted-wedge adjustment mechanism. The invention provides such an adjustable arrangement and components. These and other advantages of the invention, as well as additional inventive features, will be apparent from the description of the invention provided herein.

### BRIEF SUMMARY OF THE INVENTION

One embodiment provides a jaw crusher. The jaw crusher includes a main frame supporting a stationary jaw and a movable jaw. The jaw crusher also includes a toggle plate with a first end and second end. The first end supports the lower end of the movable jaw. The jaw crusher also includes a toggle block having a fulcrum recess which supports the toggle plate second end. A toggle taper is directly coupled to a hydraulic cylinder. Extension of the hydraulic cylinder unlocks the toggle taper from the toggle block with respect to the main frame, and retraction of the hydraulic cylinder locks the toggle taper and toggle block in a fixed position with respect to the main frame.

Another embodiment provides a kit for converting a jaw crusher having bolted wedges to a jaw crusher having hydraulic taper. The kit includes a toggle block having a sloped taper receiving zone, a toggle taper having a sloped bottom, a hydraulic cylinder, and a wedge insert.

Another embodiment of the crusher includes a main frame, a stationary jaw fixed to the main frame, a toggle block slidably supported by the main frame and having a fulcrum recess, and a moveable jaw pivotally supported at a first end relative to the frame by a toggle member at a selected position. The toggle member has a first end engaging the first end of the moveable jaw and a second end supported by the fulcrum recess. A jaw drive assembly moveably supports the moveable jaw at a second end of the moveable jaw to cyclically pivot the moveable jaw relative to the pivot. The crusher also includes a first taper guide fixed to the main frame proximate the toggle block, a second taper guide fixed to the main frame proximate the toggle block, a first moveable taper having first and second offset non-parallel surfaces with the first surface engaged with the first taper guide and the second surface engaged with the toggle block, a second moveable taper having first and second offset non-parallel surfaces with the first surface engaged with the second taper guide and the second surface engaged with the toggle block, a first cylinder connected between the first taper and the main frame, and a second cylinder connected between the second taper and the main frame. When the toggle block is moved such that the movable jaw is pivotable at the selected position, the taper's surfaces are forced into contact with the respective guides and the toggle block, and when the toggle block is to be moved, the cylinders move the tapers to reduce the force between the respective guides and the toggle block.

Another embodiment of the kit includes a first taper guide fixable to a crusher main frame proximate a crusher toggle block, a second taper guide fixed to the main frame proximate the toggle block, a first moveable taper having first and second offset non-parallel surfaces with the first surface engageable with the first taper guide and the second surface engageable with the toggle block, a second moveable taper having first and second offset non-parallel surfaces with the first surface engageable with the second taper guide and the second surface engageable with the toggle block, a first cylinder connectable between the first taper and the main frame; and a second cylinder connectable between the second taper and the main frame. When the toggle block is at a selected operating position, the cylinders operate to move the taper to an engaged position, at which, the taper's surfaces are forced into contact with the respective guides and the toggle block. The cylinders also operate to move the tapers from the engaged positions.

A further embodiment provides a method for modifying a jaw crusher. The method includes removing first and second bolted, in-place tapers from respective first and second locations on a crusher main frame, attaching a first taper guide to the crusher main frame proximate a crusher toggle block at the first location, attaching a second taper guide to the crusher main frame proximate the crusher toggle block at the second location, locating a first moveable taper having first and second offset non-parallel surfaces such that the first surface is engaged with the first taper guide and the second surface is engaged with the toggle block, locating a second moveable taper having first and second offset non-parallel surfaces such that the first surface is engaged with the second taper guide and the second surface is engaged with the toggle block, connecting a first cylinder between the first taper and the main frame, and connecting a second cylinder between the second taper and the main.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a rear view of a jaw crusher including an embodiment of the present invention;

FIG. 2 is a side cross-sectional view of a jaw crusher including an embodiment of the present invention;

FIG. 3 is a detail side cross-sectional view of a jaw crusher including an embodiment of the present invention;

FIG. 4 is a detail cross-sectional view of an embodiment of the present invention;

FIG. 5 is a top perspective cross-sectional view of a jaw crusher including an embodiment of the present invention; and

FIG. 6 is a detail perspective cross-sectional view of an embodiment of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

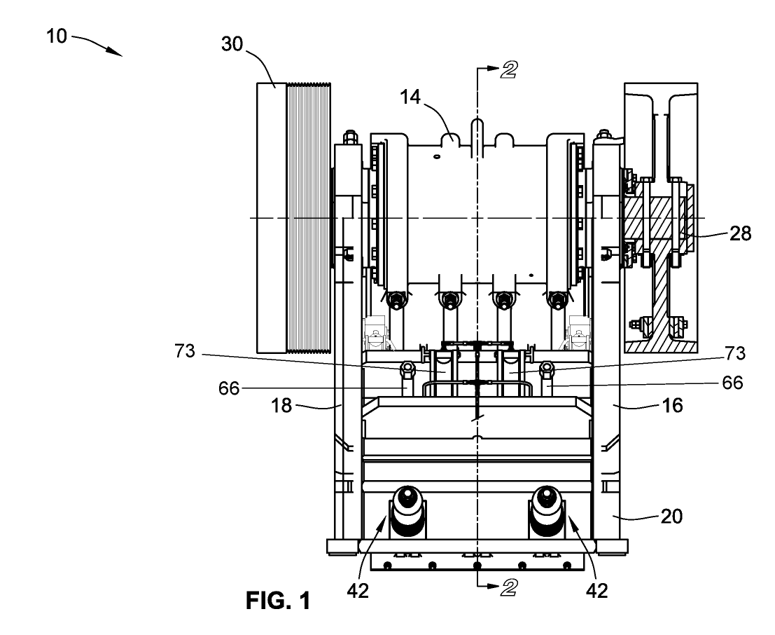

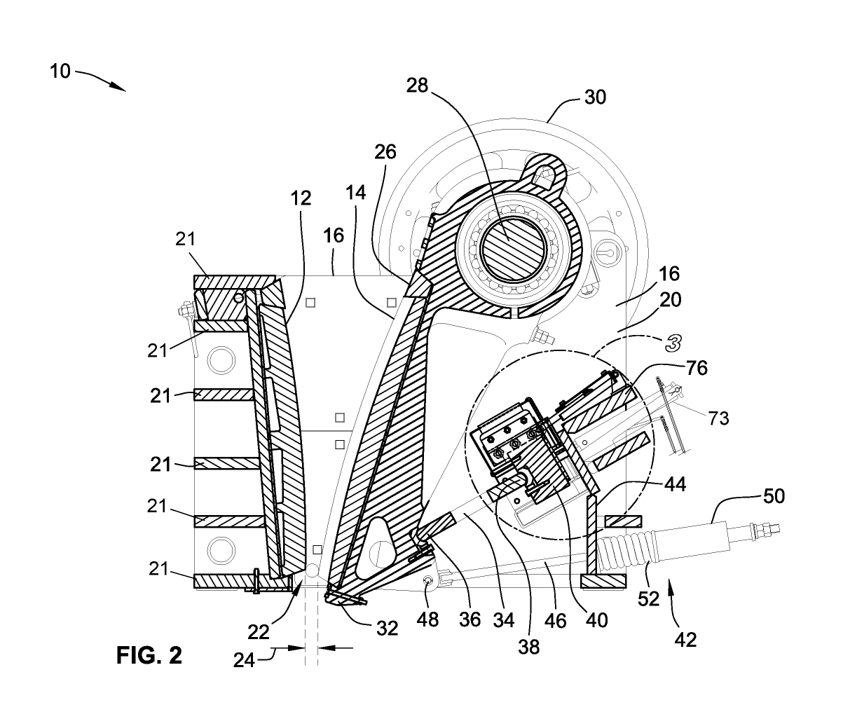

Referring to the figures, wherein like numbers refer to like elements, a jaw crusher 10 is shown. As shown in FIGS. 1 and 2, jaw crusher 10 includes a stationary jaw plate 12 and a movable jaw plate 14. Plates 12, 14 are positioned between opposing upright side walls 16, 18 of main frame 20. Side walls 16, 18 are typically each a unitary piece extending from the front of jaw crusher 10 (proximate to stationary jaw 10) to the rear of jaw crusher 10 (in the direction of movable jaw 14). Stationary jaw plate 12 is rigidly affixed to main frame 20 and is supported by cross frame elements 21 of main frame 20. Movable jaw plate 14 is positioned adjacent and rearward of stationary jaw plate 12. Jaw plates 12, 14 cooperate to crush material placed therebetween and progressively reduce the material size approaching the bottom opening 22 between jaw plates 12, 14. Bottom opening 22 defines an opening width 24 which determines the maximum size of the crushed material that is allowed to exit jaw crusher 10.

Movable jaw plate 14 is suspended at its upper end 26 from an eccentric shaft 28 that is coupled to a flywheel and sheave 30. Sheave 30 may be rotated as is generally known in the art a grooved belt and suitable drive motor (not shown).

The lower end 32 of movable jaw plate is rockably fulcrumed about the front edge 36 of toggle plate 34 at fulcrum recess 39. Toggle plate 34 extends laterally across the rear of bottom 32 of movable jaw plate 14. The rear edge 38 of toggle plate 34 is rockably fulcrumed about a toggle block 40 that is normally fixed in the housing but is adjustably shiftable forward towards movable jaw 14, or rearwards away from movable jaw 14. Toggle block 40 is positioned between side walls 16, 18 of main frame 20 and is slideable between operating positions as discussed in further detail below.

To maintain the rockable fulcrum connections between the movable jaw plate 14 and the toggle plate 34, and between the toggle plate 34 and toggle block 40, a biasing assembly 42 is connected between a cross-beam 44 of main frame 20 and the lower end 32 of movable jaw plate 14. Biasing assembly 42 urges lower end 32 towards cross-beam 44 to thereby maintain them in clamping relation to toggle plate 34. Biasing assembly 42 comprises a generally horizontally extending tension rod 46, the front end of which has a pivoted connection 48 to lower end 32 of movable jaw plate 14. Tension rod 46 extends slidably through cross beam 44. The rear portion 50 of tension rod 46 is surrounded by a coiled expansion spring 52 that applies an extension force between the cross-beam 44 the rear end 50 of the tension rod 44, thereby urging lower end 32 of movable jaw plate 14 toward cross-beam 44.

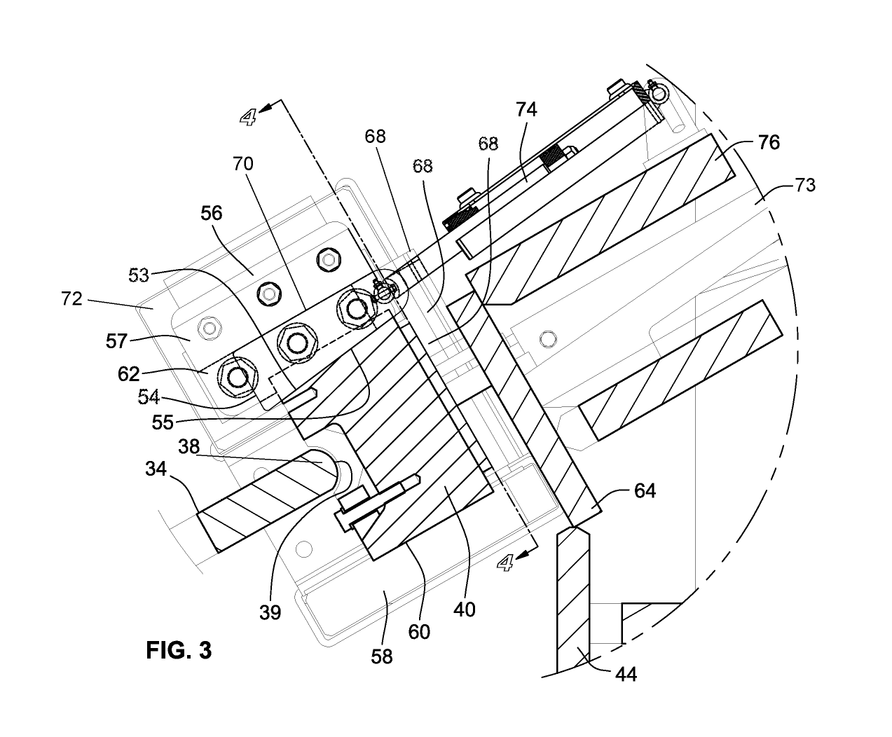

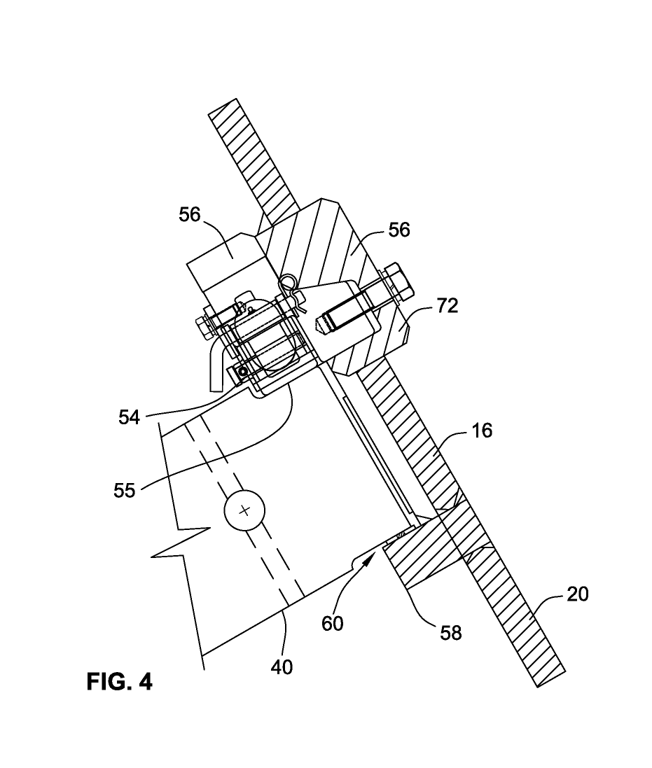

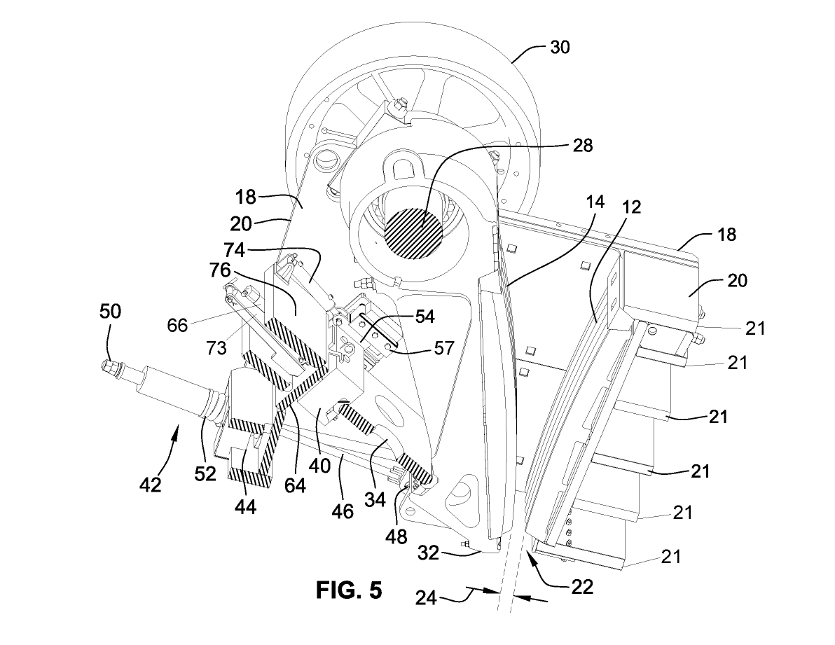

Toggle block 40 is typically has a substantial mass relative to the overall mass of crusher 10 and must be extremely well-secured to main frame 20 to maintain proper spacing of jaws 12, 14 during operation of jaw crusher 10. As shown in FIGS. 3-6, toggle block 40 is supported and held in position at the top by the bottom surface of the truncated, wedge-shaped toggle taper 54. Taper 54 is held in place and constrained from upward movement at its top surface by wedge inserts or support 56. As shown, wedge inserts 56 are removably bolted to a wedge securement point/location 72 affixed within side walls 16, 18 respectively. Wedge inserts 56 may further include a bolted plate 57 to constrain movement of toggle taper 54 towards the center line of jaw crusher 10. Toggle block 40 is supported at is lower surface by frame extensions 58 and replaceable liners 60, which extend inwardly from side walls 16, 18.

Toggle block 40 includes at least one sloped portion 55 slideably interfacing and receiving sloped portion 53 of toggle taper 54. Preferably, sloped portion 55 is located at one or more end of toggle block 40, i.e. proximate to side walls 16, 18. Sloped portion 55 of toggle block 40 is oriented with the downward slope in the direction of the front of jaw crusher 10. Movement force laterally forward and rearward on toggle tapers 54 with respect to movable jaw 14 is provided by hydraulic cylinders 74. Hydraulic cylinders 74 are each directly coupled at a movable end to toggle tapers 54, and at a stationary end to a cross beam 76 extending between side walls 16, 18.

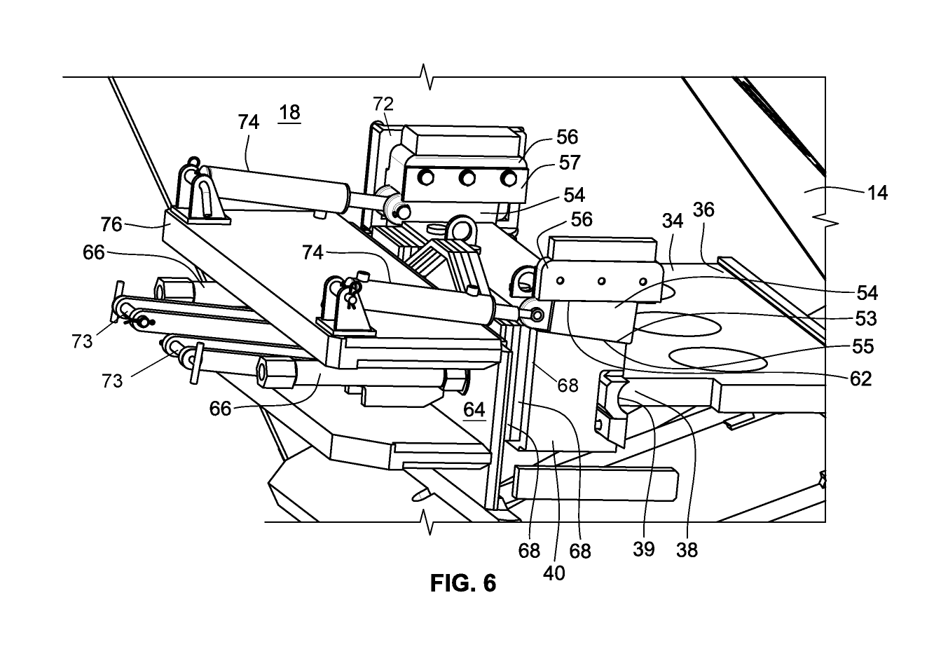

As toggle tapers 54 are hydraulically pulled backward and away from movable jaw 14 by hydraulic cylinders 74, toggle block 40 and toggle taper 54 slide with respect to each other along the interface defined by sloped portions 53 and 55, thereby increasing the effective height 70 of toggle block and wedge 40, 54 in the dimension between bottom surface 62 of wedge inserts 56 and sliding surface 60 of frame extensions 58. Toggle block and wedge 40, 54 are thereby rigidly wedged and secured within main frame 20, enabling operation of jaw crusher 10 while providing a stable dimension of jaw opening 24. In a preferred embodiment of the present invention, toggle block 40 is secured by two toggle block tapers 54 at each end of the toggle block, one proximate to side wall 16 and one proximate to side wall 18 (best shown in FIGS. 1 and 6).

Hydraulic cylinders 74 are oriented to unwedge toggle tapers 54 from toggle block 40 in the direction of moveable jaw 14 and stationary jaw 12 when hydraulic cylinders 74 are extended. The direct coupling of hydraulic cylinders 74 to toggle tapers 54 provides a mechanically simple and robust mechanism for loosening the toggle tapers 54 from the toggle block 40 that is not generally susceptible to damage during crushing operations. Additionally, toggle tapers 54 may be maintained in the securing position during crushing operations by a relatively low force exerted by hydraulic cylinders 74, allowing the toggle block/wedge to me continuously tightened during operation while retaining relative ease of removal. Depending upon the application, cylinders 74 may be operated with a conventional mechanical hydraulic pump (not shown) or with a motor driven hydraulic pump hydraulic pump and appropriate valving (not shown). Alternatively, the cylinders may be air cylinders actuated with an appropriate air pump or compressor and valve.

A toggle support wall 64 of main frame 20 extends laterally between side walls 16, 18 and is rigidly affixed thereto. In the embodiment shown, block adjustment screws 66 coupled to toggle support wall 64 and toggle block 40 are provided to move toggle block 40 laterally. When toggle tapers 54 are unlocked from toggle block 40 with respect to slide inserts 56 and supports 58, block adjustment screws 66 may be rotated to move toggle block 40 relative to toggle support wall 64, and thereby increase or decrease the width of opening 22 of jaw crusher 10. In other embodiments, toggle block 40 may be moved relative to toggle support wall 64 by one or more hydraulic cylinders 73. Block adjustment screws 66 may be insufficient to fully secure toggle block 40 against rearward motion even when toggle block 40 is wedged by toggle tapers 54. Accordingly, after adjustment of toggle block 40, shims 68 may be inserted between toggle support wall 64 and toggle block 40 to prevent rearward movement of toggle block 40 during crushing operations.

Components of the present invention may be provided in a kit form to retrofit existing jaw crushers equipped with manually bolted wedges for locking and releasing a toggle block. When components of the present invention are provided as a kit for retrofitting existing jaw crushers, wedge insert 56 operates to adapt existing securement points 72 for bolted toggle block wedges of the prior art to interface with the sloped portions 55 of toggle block 40. Additionally, such a kit will include a toggle block 40 and one or more toggle tapers 54 having mating sloped surfaces 53, 55 and one or more hydraulic cylinders 74. In other embodiments, a kit may not include a toggle block, and a toggle block 40 suitable for mating with toggle tapers 54 may be machined from a pre-existing toggle block.

All references, including publications, patent applications, and patents cited herein are hereby incorporated by reference to the same extent as if each reference were individually and specifically indicated to be incorporated by reference and were set forth in its entirety herein.

In various exemplary embodiments, the relative dimensions, including angles, lengths and radii, as shown in the Figures are to scale. Actual measurements of the Figures will disclose relative dimensions and angles of the various exemplary embodiments. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A rock crusher comprising:
a main frame;
a stationary jaw fixed to the main frame;
a toggle block slidably supported by the main frame and having a fulcrum recess;
a moveable jaw pivotally supported at a first end relative to the frame by a toggle member at a selected position, the toggle member having a first end engaging the first end of the moveable jaw and a second end supported by the fulcrum recess;
a moveable, jaw drive assembly which moveably supports the moveable jaw at a second end of the moveable jaw to cyclically pivot the moveable jaw relative to the pivot;
a first taper guide fixed to the main frame proximate the toggle block;
a second taper guide fixed to the main frame proximate the toggle block;
a first moveable taper having first and second offset non-parallel surfaces with the first surface engaged with the first taper guide and the second surface engaged with the toggle block;
a second moveable taper having first and second offset non-parallel surfaces with the first surface engaged with the second taper guide and the second surface engaged with the toggle block;
a first cylinder connected between the first taper and the main frame; and
a second cylinder connected between the second taper and the main frame, wherein when the toggle block is moved such that the movable jaw is pivotable at the selected position, the taper's surfaces are forced into contact with the respective guides and the toggle block, and when the toggle block is to be moved, the cylinders move the tapers to reduce the force between the respective guides and the toggle block.

2. The rock crusher of claim 1, wherein the toggle block is slidably supported between parallel side plates which form a portion of the main frame.

3. The rock crusher of claim 2, wherein the taper guides are bolted respective side plates above the toggle block.

4. The rock crusher of claim 3, wherein the taper guides each include a side plate for slidably capturing a respective taper.

5. The rock crusher of claim 4, wherein the drive assembly includes an offset, rotatable shaft coupled to a flywheel and motor which rotates the shaft, the shaft being supported within bearings located at the first end of moveable jaw such that the distance between the jaws cyclically varies with the rotation of the shaft.

6. The rock crusher of claim 5, further comprising a biasing mechanism for biasing the moveable jaw into a position relative to the stationary jaw.

7. The rock crusher of claim 6, wherein the biasing mechanism includes a tension bar supported between the frame and the moveable jaw.

8. The rock crusher of claim 7, further comprising a spring which biases the tension bar relative to the main frame with a force defined by an adjuster which couples the spring to the tension bar.

9. The rock crusher of claim 1, wherein the cylinders are hydraulic cylinders.

10. A kit for converting a jaw crusher with bolted, in-place tapers with cylinder-moveable tapers, the kit comprising:
a first taper guide fixable to a crusher main frame proximate a crusher toggle block;
a second taper guide fixed to the main frame proximate the toggle block;
a first moveable taper having first and second offset non-parallel surfaces with the first surface engageable with the first taper guide and the second surface engageable with the toggle block;
a second moveable taper having first and second offset non-parallel surfaces with the first surface engageable with the second taper guide and the second surface engageable with the toggle block;
a first cylinder connectable between the first taper and the main frame; and
a second cylinder connectable between the second taper and the main frame, wherein when the toggle block is in a selected operating position, the respective cylinders move the respective tapers in an engagement direction such that the surfaces of the tapers are forced into contact with the respective guides and the toggle block, and when the toggle block is to be moved, the cylinders move the tapers in a direction opposite the engagement direction.

11. The kit of claim 10, further comprising bolts for fastening the guides to the side plates of a rock crusher.

12. The kit of claim 11, wherein the guides each include side plates for slidably capturing respective tapers.

13. The kit of claim 10, wherein the cylinders are hydraulic cylinders.

14. A method for modifying a jaw crusher comprising the steps of:
removing first and second bolted, in-place tapers from respective first and second locations on a crusher main frame;
attaching a first taper guide to the crusher main frame proximate a crusher toggle block at the first location;
attaching a second taper guide to the crusher main frame proximate the crusher toggle block at the second location;
locating a first moveable taper having first and second offset non-parallel surfaces such that the first surface is engaged with the first taper guide and the second surface is engaged with the toggle block;
locating a second moveable taper having first and second offset non-parallel surfaces such that the first surface is engaged with the second taper guide and the second surface is engaged with the toggle block;
connecting a first cylinder between the first taper and the main frame; and
connecting a second cylinder between the second taper and the main.

15. The method of claim 14, further comprising the step of connecting a pressure source to the first and second cylinders.

16. The method of claim 14, wherein the steps of attaching the taper guides includes bolting the taper guides to the main frame at the respective first and second positions.

17. The method of claim 14, further comprising the step of attaching a respective side plate to each taper guide to capture a respective taper.

18. The method of claim 16, further comprising the step of attaching a respective side plate to each taper guide to capture a respective taper.

19. The method of claim 16, further comprising the step of attaching a respective side plate to each taper guide prior to attachment of the taper guides to the crusher main frame.

20. The method of claim 19, further comprising the step of connecting a pressure source to the first and second cylinders.
